(19) United States
(12) Patent Application Publication
(10) Pub. No.: US 2009/0157584 A1
(43) Pub. Date: Jun. 18, 2009

(54) FEATURE SELECTION

(76) Inventors: Guang-Zhong Yang, Surrey (GB); Xiao-Peng Hu, London (GB)

Correspondence Address: HICKMAN PALERMO TRUONG & BECKER, LLP, 2055 GATEWAY PLACE, SUITE 550, SAN JOSE, CA, 95110, US

(21) Appl. No.: 12/064,993

(22) PCT Filed: Aug. 24, 2006
(86) PCT No.: PCT/GB2006/003173

§ 371 Date: Oct. 6, 2008

(30) Foreign Application Priority Data
Sep. 2, 2005 (GB) 0517954.4

(51) Int. Cl. G06N 5/02

(52) U.S. Cl. 706/46

(57) ABSTRACT

A method of feature selection applicable to both forward selection and backward elimination of features is provided. The method selects features to be used as an input for a classifier based on an estimate of the area under the ROC curve of each of the classifiers. Exemplary applications are in homecare or patient monitoring, body sensor networks, environmental monitoring, image processing and questionnaire design.

The present invention relates to the selection of features as an input for a classifier. In particular, although not exclusively, the features are representative of the output of sensors in the sensor network, for example in a home care environment.

Techniques for dimensionality reduction have received significant attention in the field of supervised machine learning. Generally speaking, there are two groups of methods: feature extraction and feature selection. In feature extraction, the given features are transformed into a lower dimensional space, at the same time minimising loss of information. One feature extraction techniques is Principal Component Analysis (PCA), which transforms a number of correlated variables into a number of uncorrelated variables (or principal components). For feature selection on the other hand, no new features are created. The dimensionality is reduced by eliminating irrelevant and redundant features. An irrelevant (or redundant) feature provides substantially no (or no new) information about the target concept.

The aim of feature selection is to reduce the complexity of an induction system by eliminating irrelevant and redundant features. This technique is becoming increasingly important in the field of machine learning for reducing computational cost and storage, and for improving prediction accuracy. Theoretically, a high dimensional model is more accurate than a low dimensional one. However, the computational cost of an inference system increases dramatically with its dimensionality and, therefore, one must balance the accuracy against the overall computational cost. On the other hand, the accuracy of a high dimensional model may deteriorate if the model is built upon insufficient training data. In this case, the model is not able to provide a satisfactory description of the information structure. The amount of training data required to understand the intrinsic structure of an unknown system increases exponentially with its dimensionality. An imprecise description could lead to serious over-fitting problems when learning algorithms are confused by spurious structures brought about by irrelevant features. In order to obtain a computationally tractable system, less informative features, which contribute little to the overall performance, need to be eliminated. Furthermore, the high cost of collecting a vast amount of sampled data makes efficient selection strategies to remove irrelevant and redundant features desirable.

In machine learning, feature selection methods can often be divided into two groups: wrapper and filter approaches, distinguished by the relationship between feature selection and induction algorithms. A wrapper approach uses the estimated accuracy of an induction algorithm to evaluate candidate feature subsets. In contrast, filters are learned directly from data and operate independently of any specific induction algorithm. This method evaluates the “goodness” of candidate subsets based on their information content with regard to classification into target concepts. Filters are not tuned to specific interactions between the induction algorithm and information structures embedded in the training dataset. Given enough features, filter based methods attempt to eliminate features in a way that is to maintain as much information as possible about the underlying structure of the data.

One exemplary field of application where the above mentioned problems become apparent is the monitoring of a patient in a home care environment. Typically, such monitoring will involve analysing data collected from a large number of sensors, including activity sensors worn by the patient (acceleration sensors, for example), sensors monitoring the physiological state of the patient (for example temperature, blood sugar level, heart and breathing rates), as well as sensors distributed throughout the home which can be motion detectors or electrical switches which can detect the switching on and off of lights or opening and closing of doors, for example. Home care monitoring systems may have to be set up individually for each patient. In any event, collecting large amounts of training data for training a classifier which receives the outputs of the home care monitoring system may not be possible if a monitoring system is to be deployed at short notice. Accordingly, an efficient algorithm for selecting input features for a classifier is particularly desirable in the context of home care monitoring.

In a first aspect of the invention, there is provided a method of automatically selecting features as an input to a classifier as defined in claim 1. Advantageously, by using the area under the receiver operating characteristic curve of the classifier, a measure directly representative of classification performance is used in selection.

Preferably, the estimate is based on an expected area under the curve across all classes of the classifier. The feature selection may start with a full set of all available features and reduce the number of features by repeatedly omitting features from the set. Alternatively, the algorithm may start with an empty set of features and repeatedly add features. The omitted (added) feature is the one which results in the smallest (largest) change of the estimate.

Advantageously, the change may be estimated for each feature by considering the said feature and not all of the remaining features but choosing only a selection thereof. This reduces the computational requirements of the algorithms. The change may then be calculated as the difference between the expected area under the curve of the chosen remaining features together with the said feature and the expected area under the curve of the chosen remaining features without the said feature.

The method may include calculating a differential measure of the said feature and each remaining feature in the subset and choosing a predetermined number of other features having the smallest differential measure for the selection. The differential measure may be the difference in the expected area under the curve of the said feature and the expected area under the curve of the said and a remaining feature together. Advantageously, the differential measure may be pre-calculated for all features of the set prior to any selection of features taking place. This brings a further increase in computational efficiency because the differential measure only needs to be re-calculated once at the beginning of the algorithm. Features may be omitted (or added) until the number of the features in the subset to be used for classification is equal to a predetermined threshold or, alternatively until a threshold value of the expected area under the curve is reached.

The features are preferably derived from one or more channels of one or more sensors. For example, the sensors may include environmental sensors measuring quantities indicative of air, water or soil quality. Alternatively, the features may be derived from a digital image by image processing and may, for example, be representative of texture orientations, patterns or colours in the image. One or more of the features may be representative of the activity of a biomarker, which in turn may be representative of the presence or absence of a target associated with the biomarker, for example a nucleic acid, a peptide, a protein, a virus or an antigen.

In a further aspect of the invention there is provided a method of defining a sensor network as defined in claim 20. The method uses the algorithm described above. Preferably, sensors which correspond to features which are not selected by the algorithm are removed from the network.

The invention also extends to a sensor network as defined in claim 22, a home care or patient monitoring environment as defined in claim 23 and a body sensor network as defined in claim 24. The invention further extends to a system as defined in claim 25, a computer program as defined in claim 26 and a computer readable medium or data stream as defined in claim 27.

The embodiments described below are thus suitable for use in general multi-sensor environments, and in particular for general patient and/or well-being monitoring and pervasive health care.

Embodiments of the invention are now described by way of example only and with reference to the accompanying figures in which:

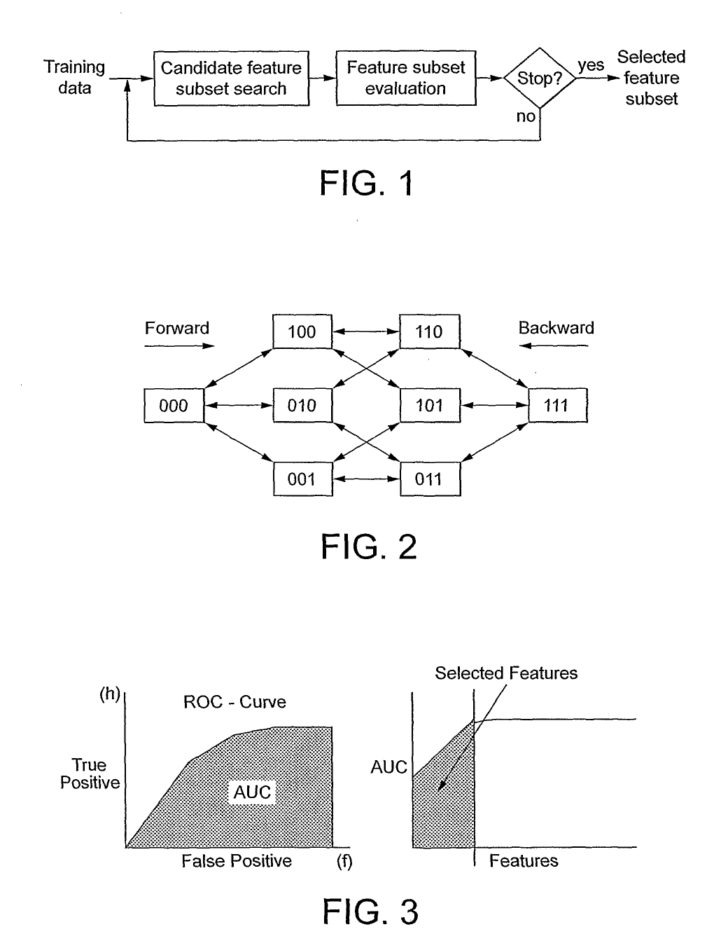

FIG. 1 illustrates a model for feature selection;

FIG. 2 illustrates a search space for selecting features of a set of three as input features;

FIG. 3 illustrates an ROC curve and feature selection according to embodiment of the invention;

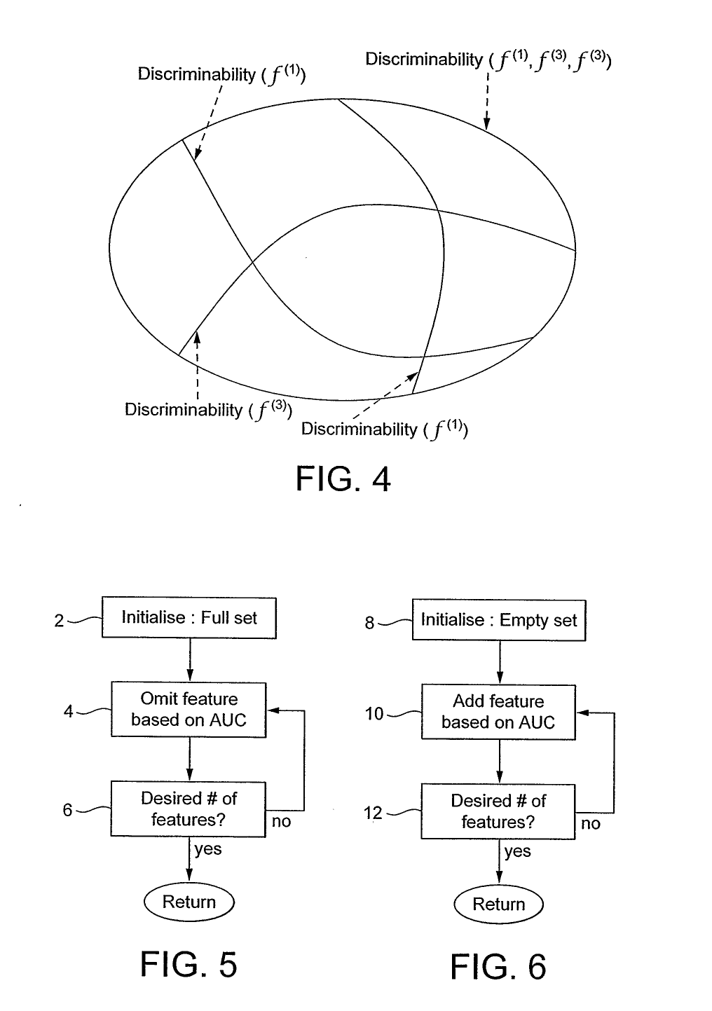

FIG. 4 is a graphical metaphor of the discriminability of sets of features;

FIG. 5 is a flow diagram of a backward elimination algorithm;

FIG. 6 is a flow diagram of a forward selection algorithm;

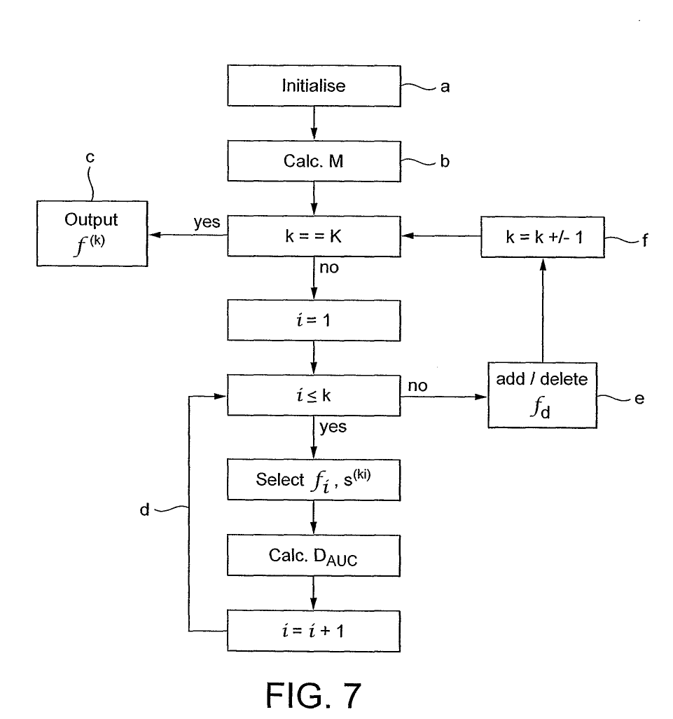

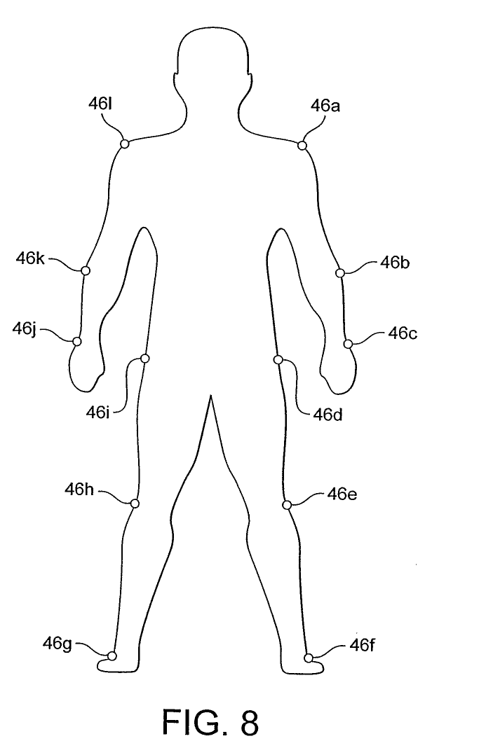

FIG. 7 is a flow diagram of an approximate backward/forward algorithm; and

FIG. 8 shows a body sensor network.

A Bayesian Framework for Feature Selection (BFFS), in overview, is concerned with the development of a feature selection algorithm based on Bayesian theory and Receiver Operating Characteristic (ROC) analysis. The proposed method has the following properties:
BFFS is based purely on the statistical distribution of the features and thus is unbiased towards a specific model
The feature selection criteria are based on the expected area under the curve of the ROC (AUC). Therefore, the features derived may yield the best classification performance in terms of sensitivity and specificity for an ideal classifier.

In Bayesian inference, the posterior probability is used for a rational observer to make decisions since it summarises the information available. We can define a measure of relevance based on conditional independence. That is, given a set of features f⁽¹⁾={fᵢ⁽¹⁾,1≦i≦N₁}, two sets of features y (the class label) and f⁽²⁾={fᵢ⁽²⁾, 1≦i≦N₂} are conditionally independent or irrelevant (that is given f⁽¹⁾, f⁽²⁾ provides no further information ), if for any assignment of y,

Pr(y|f⁽¹⁾)=Pr(y|f⁽¹⁾,f⁽²⁾), whenever Pr(f⁽¹⁾,f⁽²⁾)≠0. (1)

In this document, we use notation I(y, f⁽²⁾|f⁽¹⁾) to denote the conditional independence of y and f⁽²⁾ given f⁽¹⁾,f⁽¹⁾,f⁽²⁾ and y are assumed disjoint without losing generality.

Optimum feature subset selection involves two major difficulties: a search strategy to select candidate feature subsets and an evaluation function to assess these candidates. FIG. 1 shows a typical model for feature selection.

The size of the search space for the candidate subset selection is 2^{N}, i. e. a feature selection method needs to find the best one among 2^{N} candidate subsets given N features. As an example, FIG. 2 shows the search space for 3 features. Each state in the space represents a candidate feature subset. For instance, state 101 indicates that the second feature is not included.

Since the size of the search space grows exponentially with the number of input features, an exhaustive search of the space is impractical. As a result, a heuristic search strategy, such as the greedy search or the branch and bound search, becomes necessary. Forward selection denotes that the search strategy starts with the empty feature set, while backward elimination denotes that the search strategy starts with the full feature set. As an example, Koller and Sahami in “Towards optimal feature selection,” Proceedings of 13^{th} International Conference on Machine Learning, Bari, Italy, 1996, pp. 284-292, proposed a sequential greedy backward search algorithm to find “Markov blankets” of features based on expected cross-entropy evaluation.

By using Bayes rule, for an assignment of y=a, equation (1) can be rewritten as,

$${( 1 + \frac{Pr ( {f}^{( 1 )} \vert y \neq a )}{Pr ( {f}^{( 1 )} \vert y = a )} \times \frac{Pr ( y \neq a )}{Pr ( y = a )} )}^{- 1} = {( 1 + \frac{Pr ( {f}^{( 1 )} , {f}^{( 2 )} \vert y \neq a )}{Pr ( {f}^{( 1 )} , {f}^{( 2 )} \vert y = a )} \times \frac{Pr ( y \neq a )}{Pr ( y = a )} )}^{- 1}$$

Consequently, we can obtain an equivalent definition of relevance. Given a set of features f⁽¹⁾={fᵢ⁽¹⁾, 1≦i≦N₁}, two sets of features y and f⁽²⁾={fᵢ⁽²⁾,1≦i≦N₂} are conditionally independent or irrelevant, if for any assignment of y=a,

L(f⁽¹⁾∥y≠a, y=a)=L(f⁽¹⁾,f⁽²⁾∥y≠a, y=a), whenever Pr(f⁽¹⁾,f⁽²⁾)≠0.

where L(f∥y≠a, y=a) is the likelihood ratio,

$$L ( f ‖ y \neq a , y = a ) = \frac{Pr ( f \vert y \neq a )}{Pr ( f \vert y = a )} \qquad ( 2 )$$

A ROC can be generated by using the likelihood ratio or its equivalent as the decision variable. Given a pair of likelihoods, the best possible performance of a classifier can be described by the corresponding ROC, which can be obtained via the Neyman-Pearson ranking procedure by changing the threshold for the likelihood ratio used to distinguish between y=a and y≠a. Given two likelihoods Pr(f|y≠a) and Pr(f|y=a), the false-alarm (f) and hit (h) rates, according to the Neyman-Pearson procedure, are defined by,

$$\{ \begin{matrix}{P}_{h} = {\int }_{L ( f ‖ y \neq a , y = a ) > β} Pr ( f \vert y \neq a ) d f \\ {P}_{f} = {\int }_{L ( f ‖ y \neq a , y = a ) > β} Pr ( f \vert y = a ) d f\end{matrix} \qquad ( 3 )$$

where β is the threshold, L(f∥y≠a, y=a) is the likelihood ratio as defined by (2).

For a given β, a pair of Pₕ and P_{f} can be calculated. When β changes from ∞ to 0, Pₕ and P_{f} change from 0% to 100%. Therefore, the ROC curve is obtained by changing the threshold of the likelihood ratio.

FIG. 3 illustrates an ROC curve plotting the hit rate (h) against the false alarm rate (f), as well as the area under the curve (AUC). The right hand side of FIG. 3 shows a schematic plot of the AUC against the number of features. As illustrated in the Figure and discussed below, the AUC increases monotonically with the number of features. At the same time, the considerations discussed above put a limit on the number of features which can reasonably be used in the classifier. Embodiments of the invention discussed below provide an algorithm for selecting which features to use for the classifiers. In overview, those features which make the largest contribution to the AUC are added to an empty set one by one. Alternatively the features making the smallest contribution to the AUC are removed from a full set of features one by one. The shaded region in FIG. 3 illustrates the AUC of the selected features.

Based on the above notation, it can be proven that let f⁽¹⁾={fᵢ⁽¹⁾, 1≦i≦N₁} and f⁽²⁾={fᵢ⁽²⁾, 1≦i≦N₂}, given two pairs of likelihood distributions of Pr(f⁽¹⁾|y≠a), Pr(f⁽¹⁾|y=a) and Pr(f⁽¹⁾, f⁽²⁾|y≠a), Pr(f⁽¹⁾, f⁽²⁾|y=a), we have two corresponding ROC curves, ROC(f⁽¹⁾∥y≠a, y=a) and ROC(f⁽¹⁾,f⁽²⁾∥y≠a, y=a), obtained from the Neyman-Pearson procedure. Then, ROC(f⁽¹⁾∥y≠a, y=a)=ROC(f⁽¹⁾,f⁽²⁾∥y≠a, y=a), if and only if,

L(f⁽¹⁾∥y≠a, y=a)=L(f⁽¹⁾,f⁽²⁾∥y≠a, y=a)

where L(f˜y≠a, y=a) is the likelihood ratio defined in (6.2). We can also prove that ROC(f⁽¹⁾,f⁽²⁾∥y≠a, y=a) is not under ROC(f⁽¹⁾∥y≠a, y=a) at any point in the ROC space.

Based on these proofs, it also can be shown that, given a set of features f⁽¹⁾={fᵢ⁽¹⁾,1≦i≦N₁}, two sets of features y and f⁽²⁾={fᵢ⁽²⁾,1≦i≦N₂} are conditionally independent or irrelevant, if for any assignment of y=a,

ROC(f⁽¹⁾,f⁽²⁾∥y≠a, y=a)=ROC(f⁽¹⁾∥y≠a, y=a)

where ROC(f⁽¹⁾,f⁽²⁾≠y≠a, y=a) and ROC(f⁽¹⁾∥y≠a, y=a) are the ROC curves calculated from the Neyman-Pearson procedure given two pairs of likelihood distributions Pr(⁽¹⁾,f⁽²⁾|y≠a), Pr(f⁽¹⁾,f⁽²⁾|y=a) and Pr(f⁽¹⁾|y≠a), Pr(f⁽¹⁾|y=a), respectively.

Generally speaking, two ROC curves can be unequal when they have the same AUCs. Since f⁽¹⁾ is a subset of f⁽¹⁾ plus f⁽²⁾, we can obtain another definition of conditional independence and its relevance: given a set of features f⁽¹⁾={fᵢ⁽¹⁾,1≦i≦N₁}, two sets of features y and f⁽²⁾={fᵢ⁽²⁾, 1≦i≦N₂} are conditionally independent or irrelevant, if for any assignment of y=a,

AUC(f⁽¹⁾,f⁽²⁾∥y≠a, y=a)=AUC(f⁽¹⁾∥y≠a, y=a)

where AUC(f⁽¹⁾,f⁽²⁾∥y≠a, y=a) and AUC(f⁽¹⁾∥y≠a, y=a) are the area under the ROC curves calculated from the Neyman-Pearson procedure given two pairs of likelihood distributions Pr(f⁽¹⁾,f⁽²⁾|y≠a), Pr(f⁽¹⁾,f⁽²⁾|y=a) and Pr(f⁽¹⁾|y≠a), Pr(f⁽¹⁾|y=a) respectively.

The above statements point out the effects of feature selection on the performance of decision-making and the overall discriminability of a feature set. It indicates that irrelevant features have no influence on the performance of ideal inference, and the overall discriminability is not affected by irrelevant features.

Summarising, the conditional independence of features is determined by their intrinsic discriminability, which can be measured by the AUC. The above framework can be applied to interpret properties of conditional independence. For example, we can obtain the decomposition property

$$I ( y , ( {f}^{( 2 )} , {f}^{( 3 )} ) \vert {f}^{( 1 )} ) ⇒ \{ \begin{matrix}AUC ( {f}^{( 1 )} , {f}^{( 2 )} ‖ y \neq a , y = a ) = AUC ( {f}^{( 1 )} ‖ y \neq a , y = a ) \\ AUC ( {f}^{( 1 )} , {f}^{( 3 )} ‖ y \neq a , y = a ) = AUC ( {f}^{( 1 )} ‖ y \neq a , y = a )\end{matrix} ⇒ \{ \begin{matrix}I ( y , {f}^{( 2 )} \vert {f}^{( 1 )} ) \\ I ( y , {f}^{( 3 )} \vert {f}^{( 1 )} )\end{matrix}$$

and the contraction property,

$$\{ \begin{matrix}I ( y , {f}^{( 3 )} \vert ( {f}^{( 1 )} , {f}^{( 2 )} ) ) \\ I ( y , {f}^{( 2 )} \vert {f}^{( 1 )} )\end{matrix} ⇒ \{ \begin{matrix}AUC ( {f}^{( 1 )} , {f}^{( 2 )} , {f}^{( 3 )} ‖ y \neq a , y = a ) = AUC ( {f}^{( 1 )} , {f}^{( 2 )} ‖ y \neq a , y = a ) \\ AUC ( {f}^{( 1 )} , {f}^{( 2 )} ‖ y \neq a , y = a ) = AUC ( {f}^{( 1 )} ‖ y \neq a , y = a )\end{matrix} \\ i . e . , \\ \{ \begin{matrix}I ( y , {f}^{( 3 )} \vert ( {f}^{( 1 )} , {f}^{( 2 )} ) ) \\ I ( y , {f}^{( 2 )} \vert {f}^{( 1 )} )\end{matrix} ⇒ AUC ( {f}^{( 1 )} , {f}^{( 2 )} , {f}^{( 3 )} ‖ y \neq a , y = a ) = AUC ( {f}^{( 1 )} ‖ y \neq a , y = a ) ⇒ I ( y , ( {f}^{( 2 )} , {f}^{( 3 )} ) \vert {f}^{( 1 )} )$$

In the above equations A [symbol] B signifies that B follows from A (if A, then B) and I (A,B) means that A and B are independent.

The monotonic property stated above indicates that the overall discriminability of a feature set can be depicted by a graph metaphor. In FIG. 4, the combined ability to separate concepts is represented graphically by the union of the discriminability of each feature subset. Each region bordered by an inner curve and the outer circle represents the discriminability of a feature. There can be overlaps between features. The overall discriminability is represented by the area of the region bordered by the outer circle. Each feature subset occupies a portion of the overall discriminability. There can be overlaps between feature subsets. If one feature subset is totally overlapped by other feature subsets, it provides no additional information, and therefore can be safely removed without losing the overall discriminability. It needs to be pointed out that the position and area occupied by a feature subset can change when new features are included.

By applying the contraction and decomposition properties (as described above), we have the following properties for feature selection,

$$\{ \begin{matrix}I ( y , {f}^{( 3 )} \vert ( {f}^{( 1 )} , {f}^{( 2 )} ) ) \\ I ( y , {f}^{( 2 )} \vert {f}^{( 1 )} )\end{matrix} ⇒ I ( y , ( {f}^{( 2 )} , {f}^{( 3 )} ) \vert {f}^{( 1 )} ) ⇒ \{ \begin{matrix}I ( y , {f}^{( 3 )} \vert ( {f}^{( 1 )} ) \\ I ( y , {f}^{( 2 )} \vert {f}^{( 1 )} )\end{matrix}$$

In the above equation, I(y, f⁽³⁾|f⁽¹⁾,f⁽²⁾) and I(y, f⁽²⁾|f⁽¹⁾) represent two steps of elimination, i.e. features in f⁽³⁾ can be removed when features in f⁽¹⁾ and f⁽²⁾ are given. This can be immediately followed by another elimination of features in f⁽²⁾ owing to the existence of features in f⁽²⁾. I(y, f⁽³⁾|f⁽¹⁾) indicates that features in f⁽³⁾ remain irrelevant after features in f⁽²⁾ are eliminated. As a result, only truly irrelevant features are removed at each iteration by following the backward elimination process. In general, backward elimination is hence less susceptible to feature interaction than forward selection.

Because the strong union property I (y, f⁽²⁾|f⁽¹⁾) [symbol] I (y, f⁽²⁾|f⁽¹⁾, f⁽³⁾) does not generally hold for conditional independence, irrelevant features can become relevant if more features are added. Theoretically, this could limit the capacity of low dimensional approximations or forward selection algorithms. In practice, however, the forward selection and approximate algorithms proposed below tend to select features that have large discriminability and provide new information. For example, a forward selection algorithm may be preferable in situations where it is known that only a few of a large set of features are relevant and interaction between features is not expected to be a dominant effect.

Turning now to the case of multiple classes, we denote that the set of possible values of the class label y is {aᵢ, i=1, N}, N being the number of classes. AUC(f ∥y≠aᵢ, y=aᵢ) denotes the area under the ROC curve of Pr(f|y≠aᵢ) and Pr(f|y=aᵢ). The expectation of the AUC over classes may be used as an evaluation function for feature selection:

$${E}_{AUC} ( f ) = E ( AUC ( f ) ) = {\sum }_{i = 1}^{N} Pr ( y = {a}_{i} ) AUC ( f ‖ y \neq {a}_{i} , y = {a}_{i} ) \qquad ( 6 )$$

In the above equation, the prior probabilities Pr(y=aᵢ) can be either estimated from data or determined empirically to take misjudgement costs into account. The use of the expected AUC as an evaluation function follows the same principle of sensitivity and specificity. It is not difficulty to prove that E_{AUC}(f⁽¹⁾, f⁽²⁾)=E_{AUC}(f⁽¹⁾) is equivalent to AUC(f⁽¹⁾,f⁽²⁾∥y≠aᵢ, y=aᵢ)=AUC(f⁽¹⁾∥y≠aᵢ, y=aᵢ), {i=1, N}; i.e. features in f⁽²⁾ are irrelevant given features in f⁽¹⁾. E_{AUC}(f) is also a monotonic function that increases with feature number, and 0.5≦E_{AUC}(f)≦1.0. For a binary class, E_{AUC}(f)=AUC(f∥y=a₁, y=a₂)=AUC(f∥y=a₂, y=a₁), i.e. the calculation of E_{AUC}(f) is not affected by prior probabilities.

To use likelihood distributions for calculating the expected AUC in multiple-class situations, we need to evaluate Pr(f|y≠aᵢ) in (6). By using Bayes rule, we have,

$$\begin{matrix}Pr ( f \vert y \neq {a}_{i} ) = \frac{Pr ( y \neq {a}_{i} \vert f ) Pr ( f )}{Pr ( y \neq {a}_{i} )} \\ = \frac{{\sum }_{k = 1 , N}^{k \neq i} Pr ( y = {a}_{k} \vert f ) Pr ( f )}{{\sum }_{j = 1 , N}^{j \neq i} Pr ( y = {a}_{j} )} \\ = \frac{{\sum }_{k = 1 , N}^{k \neq i} Pr ( y = {a}_{k} ) Pr ( f \vert y = {a}_{k} )}{{\sum }_{j = 1 , N}^{j \neq i} Pr ( y = {a}_{j} )} \\ = {\sum }_{k = 1 , N}^{k \neq i} {C}_{ki} Pr ( f \vert y = {a}_{k} )\end{matrix} \\ where \\ {C}_{ki} = \frac{Pr ( y = {a}_{k} )}{{\sum }_{j = 1 , N}^{j \neq i} Pr ( y = {a}_{j} )} ( i \neq k ) \qquad ( 7 )$$

By assuming that the decision variable and decision rule for calculating AUC(f ∥y=aₖ, y=aᵢ) and AUC(f∥y≠aᵢ, y=aᵢ) are the same we have,

$$AUC ( f ‖ y \neq {a}_{i} , y = {a}_{i} ) = {\sum }_{k = 1 , N}^{k \neq i} {C}_{ki} AUC ( f ‖ y = {a}_{k} , y = {a}_{i} ) \qquad ( 8 )$$

where AUC(f∥y=aₖ, y=aᵢ) represents the area under the ROC curve given two likelihood distributions Pr(f|y=aₖ) and Pr(f|y=aᵢ) (i≠k).

Equation (8) is used for evaluating AUC(f∥y≠aᵢ, y=aᵢ) for multiple-class cases. By substituting (8) into (6), we have,

$${E}_{AUC} ( f ) = {\sum }_{i = 1}^{N} ( Pr ( y = {a}_{i} ) {\sum }_{k = 1 , N}^{k \neq i} {C}_{ki} AUC ( f ‖ y = {a}_{k} , y = {a}_{i} ) ) \qquad ( 9 )$$

Since removing or adding an irrelevant feature does not change the expected AUC, both backward and forward greedy selection (filter) algorithms can be designed to use the expected AUC as an evaluation function.

A backward elimination embodiment of the invention provides a greedy algorithm for feature selection. It starts with the full feature set and removes one feature at each iteration. A feature fⱼ∈f^{(k)} to be removed is determined by using the following equation,

$${f}_{j} = {arg min}_{{f}_{i} ∉ {f}^{( k )}} ( {E}_{AUC} ( {f}^{( k )} ) - {E}_{AUC} ( {f}^{( k )} \backslash \{ {f}_{i} \} ) ) \qquad ( 10 )$$

where f^{(k)}={fᵢ, 1≦i≦L} is the temporary feature set after kth iteration and f^{(k)}\{fᵢ} is the set f^{(k)} with fᵢ removed.

With reference to FIG. 5, an algorithm of the backward elimination embodiment has a first initialisation step 2 at which all features are selected followed by step 4 omitting the feature which makes the smallest contribution for the AUC, as described above. At step 6 algorithm tests whether the desired number of features are selected and, if not, loops back to the feature omission step 4. If the desired number of features has been selected, the algorithm returns.

Analogously to the backward elimination embodiment, a forward selection embodiment also provides an algorithm for feature selection. With reference to FIG. 6, the algorithm initialises by selecting an empty set at step 8 and at step 10 adds the feature which makes the greatest contribution to the AUC to the set of features selected for the classifiers. Again, step 12 tests if the desired number of features is reached and if not loops back to step 10 until the desired number of features is reached and the algorithm returns.

In the forward and backward embodiments described above, the stopping condition (steps 6 and 12) test whether the selected set of features has the desired number of features. Alternatively, the stopping criteria could test whether the expected AUC has reached a predetermined threshold value. That is, for backward elimination the algorithm continues until the expected AUC drops below the threshold. In order to ensure that the threshold represents a lower bound for the expected AUC, the last omitted feature can be added again to the selected set. For forward selection, the algorithm could exit when the expected AUC exceeds the threshold.

Estimating the AUC in high dimensional space is time consuming. The accuracy of the estimated likelihood distribution decreases dramatically with the number of features given limited training samples, which in turn introduces ranking error in the AUC estimation. Therefore, an approximation algorithm is necessary to estimate the AUC in a lower dimensional space when training data is limited.

As explained earlier the decrease of the total AUC after removal of a feature fᵢ is related to the overlap of the discriminability of the feature with other features. In the approximation algorithm, we attempt to construct a feature subset S^{(k)} from the current feature set f^{(k)} and use the degree of discriminability overlap in S^{(k)} to approximate that f^{(k)}. A heuristic approach is designed to select kₛ features from f^{(k)} that have the largest overlap with feature fᵢ and we assume that the discriminability overlap of feature fᵢ with other features in f^{(k)} is dominated by this subset of features. Therefore, the approximation algorithm of backward elimination for selecting K features is as follows with reference to FIG. 7. ∪ signifies the set union and \ signifies the set complement.
(a) Let f^{(k)} be the full feature set and k be the size of the full feature set.
(b) Calculate the discriminability differential matrix M(fᵢ, fⱼ); fᵢ∈f^{(k)},fⱼ∈f^{(k)}, fᵢ≠fⱼ.

M(fᵢ,fⱼ)=E_{AUC}({fᵢ,fⱼ})−E_{AUC}({fⱼ})
(c) If k=K, output f^{(k)}.
(d) For fᵢ∈f^{(k)} (i=1,k)
   select kₛ features from f^{(k)} to construct a feature subset S^{(ki)}. The criterion of the selection is to find the kₛ features fⱼ, for which M(fᵢ, fⱼ) is smallest, where fⱼ∈f^{(k)}, fⱼ≠fᵢ.
   calculate D_{AUC}.
(e) Select feature f_{d} which is the fᵢ with the smallest D_{AUC} (fi); set f^{(k)}=f^{(k)}−{f_{d}};
(f) k=k−1; goto (c).

The approximation algorithm for forward selection is similar and also described with reference to FIG. 7:
(a) Let f^{(k)} be empty and k be zero.
(b) Calculate the discriminability differential matrix M(fᵢ, fⱼ); fᵢ∈f^{(k)}, fⱼ∈j^{(k)}, fᵢ≠fⱼ.

M(fᵢ,fⱼ)=E_{AUC}({f_{i,f}ⱼ})−E_{AUC}({fⱼ})
(c) If k=K, output f^{(k)}.
(d) For fᵢ∈f^{(k)} (i−1,k)
   select kₛ features from f^{(k)} to construct a feature subset S^{(ki)}. The criterion of the selection is to find the kₛ feature fⱼ, for which M(fᵢ, fⱼ) is smallest, where fⱼ∈f^{(k)}, fⱼ≠fᵢ.
   calculate D_{AUC}.

D_{AUC}(fᵢ)=E_{AUC}(S^{(ki)}U{fᵢ})−E_{AUC}(S^{(ki)})
(e) Select feature f_{d} which is the fᵢ with the largest D_{AUC}(fᵢ); f⁽ⁱ⁾=f⁽ⁱ⁾ U{f_{d}};
(f) k=k+1 goto (c).

Determining a proper value of kₛ is related to several factors, such as the degree of feature interaction and the size of the training dataset. In practice, kₛ should not be very large when the interaction between features is not strong and the training dataset is limited. For example, kₛ={1, 2, 3} has been found to produce good results, with kₛ=3 being preferred. In some cases the choice of kₛ=4 or 5 may be preferred. The choice of kₛ represents a trade-off between the accuracy of the approximation and the risk of over-fitting if training data is limited.

It is understood that algorithms according to the above embodiments can be used to select input features for any kind of suitable classifier. The features may be related directly to the output of one or more sensors or a sensor network used for classification, for example a time sample of the sensor signals may be used as the set of features. Alternatively, the features may be derived measures derived from the sensor signals. While embodiments of the invention have been described with reference to an application in home care monitoring it is apparent to the skilled person that the invention is applicable to any kind of classification problem requiring the selection of input features.

A specific example of the algorithm described above being applied is now described with reference to FIG. 8, showing a human subject 44 with a set of acceleration sensors 46a to 46g attached at various locations on the body. A classifier is used to infer a subject's body posture or activity from the acceleration sensors on the subject's body.

The sensors 46a to 46g detect acceleration of the body at the sensor location, including a constant acceleration due to gravity. Each sensor measures acceleration along three perpendicular axes and it is therefore possible to derive both the orientation of the sensor with respect to gravity from a constant component of the sensor signal, as well as information on the subject's movement from the temporal variations of the acceleration signals.

As shown in FIG. 8, sensors are positioned across the body (one for each shoulder, elbow, wrist, knee and ankle) giving a total of 36 channels or features (3 per sensor) transmitted to a central processor of sufficient processing capacity.

The algorithm described above can be used to find those sensors which optimally distinguishes the causes of posture and movement in question. To this end, the expected AUC can be determined experimentally by considering the signals of only certain sensors at a time, as described above in the general form with respect to input features. The expected AUC obtained in this way is then used to select sensors (or channels thereof) as an input to the classifier.

Home care or patient monitoring is another field of application. In homecare or patient monitoring, features may include activity-related signals derived from sensors in the environment (e.g. IR motion detectors) or on the patient (e.g. acceleration sensors), as well as sensors of physiological parameters such as respiration rate and/or volume, blood pressure, perspiration or blood sugar.

Other applications are, for example, in environmental monitoring, where the sensors may be measuring quantities indicative of air, water or soil quality. The algorithms may also find applications in image classification where the features would be derived from a digital image by image processing and may be representative of texture orientations, patterns or colours in the image.

A further application of the algorithms described above may be in drug discovery or the design of diagnostic applications where it is desirable to determine which of a number of biomarkers are indicative of a certain condition or relate to a promising drug target. To this end, data sets of activity of biomarkers for a given condition or treatment outcome are collected and then analysed using the algorithms described above to detect which biomarkers are actually informative.

The algorithms described above provide a principled way in which to select useful biomarkers. For example, the activity of the biomarker may be representative of the presence or absence of a target molecule associated with the biomarker. The target may be a certain nucleic acid, a peptide, a protein, a virus or an antigen.

A further application of the described algorithms is in designing a questionnaire for opinion polls and surveys. In this case, the algorithms can be used for selecting informative questions from a pool of questions in a preliminary pool or study. The selected questions can then be used in a subsequent large-scale pool or study allowing it to be more focussed.

The embodiments discussed above describe a method for selecting features as an input to a classifier and will be apparent to a skilled person that such a method can be employed in a number of contexts in addition to the ones mentioned specifically above. The specific embodiments described above are meant to illustrate, by way of example only, the invention, which is defined by the claims set out below.

1. A method of automatically selecting features as an input to a classifier for a plurality of classes including calculating an estimate of the area under a receiver operating characteristic curve for each class of the classifier, and selecting the said features in dependence upon the said estimates.

2. A method as described in claim 1 in which the estimate is calculated in dependence upon an expected area under the curve calculated as a prior probability weighted sum of the area under the curve of each class.

3. A method as described in claim 2 in which the selecting includes starting with a set of features and repeatedly omitting a feature, the said feature being selected such that its omission results in the smallest change of the estimate for the resulting subset.

4. A method as described in claim 2 in which the selecting includes starting with an empty subset and repeatedly adding to the subset a feature, the said feature being selected such that its omission results in the largest change of the estimate for the resulting subset.

5. A method as claimed in claim 3 in which the change is estimated for each feature of the subset by considering the said feature and only a selection of the remaining features.

6. A method as claimed in claim 5 in which the change is calculated as a difference between the estimate of the expected area under the curve of the said selection of the remaining features and the said feature and the estimate of the expected area under the curve of the said selection of remaining features.

7. A method as claimed in claim 5 in which the method includes calculating a respective differential measure of the said feature and each remaining feature in the subset and choosing a predetermined number of the remaining features having the smallest respective differential measure for the said selection.

8. A method as claimed in claim 7 in which the respective differential measure is the difference in the estimate of the expected area under the curve for the said feature and the estimate of the expected area under the curve for the said feature and the respective remaining feature.

9. A method as claimed in claim 7 in which the differential measure is calculated for all features of the set prior to selecting any of the features.

10. A method as claimed in claim 3, in which features are added to or omitted from the subset until the subset includes a predetermined number of features.

11. A method as claimed in claim 3 in which features are added to or omitted from the subset until the estimate reaches a desired level.

12. A method as claimed in claim 1 in which one or more features are derived from one or more channels from one or more sensors.

13. A method as claimed in claim 12 in which the sensors include environmental sensors measuring quantities indicative of air, water or soil quality.

14. A method as claimed in claim 1 in which one or more features are derived from a digital image by image processing.

15. A method as claimed in claim 14, the derived features being representative of texture orientations, patterns or colours in the image.

16. A method as claimed in claim 1 in which one or more features are representative of the activity of a biomarker.

17. A method as claimed in claim 16 in which the activity of the biomarker is representative of the presence or absence of a target associated with the biomarker.

18. A method as claimed in claim 17, in which the target is a nucleic acid, a peptide, a protein, a virus or an antigen.

19. A method as claimed in claim 1, in which the features include questions in an opinion poll or survey.

20. A method of defining a sensor network of a plurality of sensors in an environment including acquiring a data set of features corresponding to the sensors and selecting features as an input to a classifier for a plurality of classes including calculating an estimate of the area under a receiver operating characteristic curve for each class of the classifier, and selecting the said features in dependence upon the said estimates.

21. A method as claimed in claim 20, including removing from the environment any sensors corresponding to features not selected.

22. A sensor network of a plurality of sensors in an environment by the process of: acquiring a data set of features corresponding to the sensors and selecting features as an input to a classifier for a plurality of classes including calculating an estimate of the area under a receiver operating characteristic curve for each class of the classifier, and selecting the said features in dependence upon the said estimates.

23. A homecare or patient monitoring environment including a sensor network of a plurality of sensors in an environment defined by the process of: acquiring a data set of features corresponding to the sensors and selecting features as an input to a classifier for a plurality of classes including calculating an estimate of the area under a receiver operating characteristic curve for each class of the classifier, and selecting the said features in dependence upon the said estimates.

24. A body sensor network including a sensor network of a plurality of sensors in an environment defined by the process of: acquiring a data set of features corresponding to the sensors and selecting features as an input to a classifier for a plurality of classes including calculating an estimate of the area under a receiver operating characteristic curve for each class of the classifier, and selecting the said features in dependence upon the said estimates.

25. A computer system arranged to implement a method comprising: automatically selecting features as an input to a classifier for a plurality of classes including calculating an estimate of the area under a receiver operating characteristic curve for each class of the classifier, and selecting the said features in dependence upon the said estimates.

26. (canceled)

27. A computer readable storage medium carrying a computer program which when executed by one or more processors causes the one or more processors to perform: automatically selecting features as an input to a classifier for a plurality of classes including calculating an estimate of the area under a receiver operating characteristic curve for each class of the classifier, and selecting the said features in dependence upon the said estimates.

28. A method as claimed in claim 4 in which the change is estimated for each feature of the subset by considering the said feature and only a selection of the remaining features.

29. A method as claimed in claim 6 in which the method includes calculating a respective differential measure of the said feature and each remaining feature in the subset and choosing a predetermined number of the remaining features having the smallest respective differential measure for the said selection.

30. A method as claimed in claim 8 in which the differential measure is calculated for all features of the set prior to selecting any of the features.
